(19) United States
(12) Patent Application Publication
(10) Pub. No.: US 2025/0267436 A1
(43) Pub. Date: Aug. 21, 2025

(54) METHOD AND APPARATUS FOR CLIENT-CENTRIC REMOTE PROFILE PROVISIONING ON M2M IOT DEVICES SUPPORTING ESIM

(71) Applicant: Electronics and Telecommunications Research Institute, Daejeon (KR)

(72) Inventors: Bo-Heung CHUNG, Daejeon (KR); Yousung KANG, Daejeon (KR); Keonwoo KIM, Daejeon (KR); Taesung KIM, Daejeon (KR); SungJin YU, Daejeon (KR); Joonyoung LEE, Daejeon (KR)

(73) Assignee: Electronics and Telecommunications Research Institute, Daejeon (KR)

(21) Appl. No.: 18/923,181

(22) Filed: Oct. 22, 2024

(30) Foreign Application Priority Data
Feb. 20, 2024 (KR) 10-2024-0024100

(51) Int. Cl. H04W 4/50; H04W 8/18

(52) U.S. Cl. CPC H04W 4/50; H04W 8/18

(57) ABSTRACT

Provided is a method and apparatus for remote profile provisioning for an Internet of Things (IoT) device supporting an e-subscriber identity module (eSIM). The method and apparatus perform bidirectional profile provisioning for machine to machine (M2M) IoT devices. The present invention does not unilaterally perform server-centric provisioning on a client, but uses a newly designed message type and format for client-centric provisioning and concurrent provisioning, in consideration of the initiator and direction of provisioning and the need for concurrent provisioning.

### CROSS-REFERENCE TO RELATED APPLICATION

This application claims priority to and the benefit of Korean Patent Application No. 10-2024-0024100, filed on Feb. 20, 2024, the disclosure of which is incorporated herein by reference in its entirety.

### BACKGROUND

### 1. Field of the Invention

The present invention relates to a method and apparatus for provisioning an embedded subscriber identity module (eSIM) profile for an apparatus with an eSIM operated in a machine to machine (M2M) manner.

### 2. Discussion of Related Art

With the development of the Internet of Things (IoT) and machine to machine (M2M) technologies, various wireless access technologies and services utilizing the technologies have become widespread, resulting in an increasing need to connect and manage millions of apparatuses for providing the services. In order to register the apparatus in the network and authenticate the apparatus, a subscriber identity module (SIM) card is used, but there are limitations in distributing physical card type SIMs to a large number of IoT devices. Similar to SIMs, embedded SIM (eSIMs) are used to store user identification data and perform authentication. However, unlike SIMs, eSIMs are attached to a board during device production, thereby removing the need for physical replacement. Additionally, an eSIM occupies three times less space than a nano-SIM card, thereby allowing devices to be smaller and better protected from moisture and dust. In addition, since an eSIM may store up to 5 virtual SIM cards or profiles, it is possible to easily change mobile network operators (MNOs) without needing to visit a store or office to physically replace the card.

A process of applying a profile to an eSIM is performed through a remote SIM provisioning (RSP) protocol. The RSP service is a process in which a remote server (subscription manager-data preparation: SM-DP) generates a profile and the profile is downloaded and installed on an eSIM in a device through a secure communication channel. Since this process takes a relatively long time (minutes) to set up a secure channel and download a profile, when performing a process of simply installing subscriber profiles in bulk or changing all profiles during operation rather than selecting some device and applying profiles to the devices, repetitive and time-consuming tasks occur. Additionally, when the RSP is desired due to client-centric needs, such as due to a need to replace a device having a malfunction with a new device, the RSP cannot be performed in the conventional way.

### SUMMARY OF THE INVENTION

The present invention is directed to providing a method and apparatus for remote profile provisioning for a machine to machine (M2M) Internet of Things (IoT) device supporting an embedded subscriber identity module (eSIM). The method and apparatus according to the present invention perform bidirectional profile provisioning for M2M IoT devices. The present invention does not unilaterally perform server-centric provisioning on a client, but uses a new message format in consideration of the initiator and direction of provisioning and the need for concurrent provisioning. Therefore, the present invention is provided to providing a method and apparatus for bidirectional provisioning that may be applied not only to server-centric provisioning but also to client-centric provisioning at a desired time and when a device requires client-centric provisioning.

The technical objectives of the present invention are not limited to the above, and other objectives may become apparent to those of ordinary skill in the art based on the following description.

According to an aspect of the present invention, there is provided a method of client-centric remote profile provisioning, which is a method of remote profile provisioning for an IoT device supporting an eSIM. The method includes: generating, by a provisioning control server, a first topic to which a remote SIM provisioning (RSP) server is configured to subscribe and a second topic to which an IoT device is configured to subscribe, according to a message queueing telemetry transport (MQTT) protocol; publishing, by a first IoT device, a triggering message to start provisioning to the first topic to request the RSP server to publish a profile to be applied to the first IoT device; and publishing, by the RSP server, the profile to the second topic in response to the triggering message.

The method may further include downloading, by the first IoT device, the profile from the second topic.

The method may further include, when the second topic is set to a multi-mode, downloading, by a second IoT device subscribing to the second topic, the profile from the second topic when the profile is published to the second topic by the RSP server.

The method may further include publishing, by a third IoT device subscribing to the second topic, a triggering message to start provisioning to the second topic with the first IoT device as a receiving target to request the first IoT device to publish the profile.

The method may further include: receiving, by the first IoT device, the triggering message published by the third IoT device from the second topic; publishing, by the first IoT device, the profile to the second topic with the third IoT device as a receiving target; and downloading, by the third IoT device, the profile from the second topic when the first IoT device publishes the profile to the second topic.

According to an aspect of the present invention, there is provided a system for remote profile provisioning for an IoT device supporting an eSIM. The system includes: a provisioning control server configured to operate a first topic and a second topic generated according to an MQTT protocol; an RSP server configured to subscribe to the first topic; and a first IoT device configured to subscribe to the second topic, wherein the RSP server publishes a profile to be applied to the first IoT device to the second topic, and the first IoT device downloads the profile from the second topic.

Before downloading the profile, the first IoT device may publish a triggering message to start provisioning to the first topic to request the RSP server to publish the profile.

Before publishing the profile to the second topic, the RSP server may publish a triggering message to start provisioning to the second topic to request the first IoT device to download the profile.

The system may further include a second IoT device subscribing to the second topic, wherein the provisioning control server may set the second topic to one of a multi-mode and a single mode, and when the second topic is set to the multi-mode, the second IoT device may download the profile from the second topic in response to the RSP server publishing the profile to the second topic.

The system may further include a third IoT device subscribing to the second topic, wherein the third IoT device may publish a triggering message to start provisioning to the second topic with the first IoT device as a receiving target to request the first IoT device to publish the profile.

Upon receiving the triggering message published by the third IoT device from the second topic, the first IoT device may publish the profile to the second topic with the third IoT device as a receiving target, and when the first IoT device publishes the profile to the second topic, the third IoT device may download the profile from the second topic.

According to an aspect of the present invention, there is provided a system for remote profile provisioning for an IoT device supporting an eSIM. The system includes: an RSP server configured to operate a first topic and a second topic generated according to an MQTT protocol, and subscribe to the first topic; and a first IoT device configured to subscribe to the second topic, wherein the RSP server publishes a profile to be applied to the first IoT device to the second topic, and the first IoT device downloads the profile from the second topic.

Before downloading the profile, the first IoT device may publish a triggering message to start provisioning to the first topic to request the RSP server to publish the profile.

Before publishing the profile to the second topic, the RSP server may publish a triggering message to start provisioning to the second topic to request the first IoT device to download the profile.

The system may further include a second IoT device subscribing to the second topic, wherein the RSP server may set the second topic to one of a multi-mode and a single mode, and when the second topic is set to the multi-mode, the second IoT device may download the profile from the second topic in response to the RSP server publishing the profile to the second topic.

The system may further include a third IoT device subscribing to the second topic, wherein the third IoT device may publish a triggering message to start provisioning to the second topic with the first IoT device as a receiving target to request the first IoT device to publish the profile.

Upon receiving the triggering message published by the third IoT device from the second topic, the first IoT device may publish the profile to the second topic with the third IoT device as a receiving target, and when the first IoT device publishes the profile to the second topic, the third IoT device may download the profile from the second topic.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIGS. 1A and 1B are diagrams illustrating a general provisioning procedure;

FIG. 2 is a diagram illustrating a method of provisioning having concurrency for machine to machine (M2M) Internet of Things (IoT) devices;

FIGS. 3A to 3C are diagrams illustrating considerations and operation flows of client-centric remote profile provisioning according to the present invention;

FIG. 4 is a diagram for describing an operation of a client-based provisioning control unit according to an embodiment of the present invention;

FIGS. 5A to 5D are diagrams illustrating operation flows of client-centric remote profile provisioning according to an embodiment of the present invention;

FIGS. 6A to 6D are diagrams for describing an embodiment of a method of remote profile provisioning according to an embodiment of the present invention;

FIGS. 7A to 7G are diagrams for describing a method of remote profile provisioning according to an embodiment of the present invention;

FIG. 8 is a block diagram illustrating a configuration of a system for remote profile provisioning according to an embodiment of the present invention;

FIG. 9 is a flowchart showing a method of client-centric remote profile provisioning according to an embodiment of the present invention; and

FIG. 10 is a block diagram illustrating a computer system for implementing a method of remote profile provisioning according to an embodiment of the present invention.

### DETAILED DESCRIPTION OF EXEMPLARY EMBODIMENTS

The advantages and features of the present invention and ways of achieving them will become readily apparent with reference to the following embodiments described in detail in conjunction with the accompanying drawings. However, the present invention is not limited to such embodiments and may be embodied in various forms. The embodiments to be described below are provided only to make the disclosure of the present invention complete and assist those of ordinary skill in the art in fully understanding the scope of the present invention, and the scope of the present invention is defined only by the appended claims. Terms used herein are used for describing the embodiments and are not intended to limit the scope and spirit of the present invention. It should be understood that the singular forms “a” and “an” also include the plural forms unless the context clearly dictates otherwise. The terms “comprise,” “comprising,” “include,” and/or “including” used herein specify the presence of stated features, integers, steps, operations, elements, components and/or groups thereof and do not preclude the presence or addition of one or more other features, integers, steps, operations, elements, components, and/or groups thereof.

It should be understood that, although the terms “first,” “second,” etc. may be used herein to describe various elements, these elements are not limited by these terms. These terms are only used for distinguishing one element from another. For example, a first element could be called a second element without departing from the scope of the present invention.

It will be understood that when a first element is referred to as being “connected” or “coupled” to a second element, the first element can be directly connected or coupled to the second element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

In the description of the embodiments, the detailed description of related known functions or configuration will be omitted herein to avoid making the subject matter of the present invention unclear.

Hereinafter, the present invention will be described in detail by describing exemplary embodiments of the present invention with reference to the accompanying drawings. In the drawings, parts irrelevant to the description may be omitted for the clarity of explanation, and like numbers refer to like elements throughout the description of the drawings.

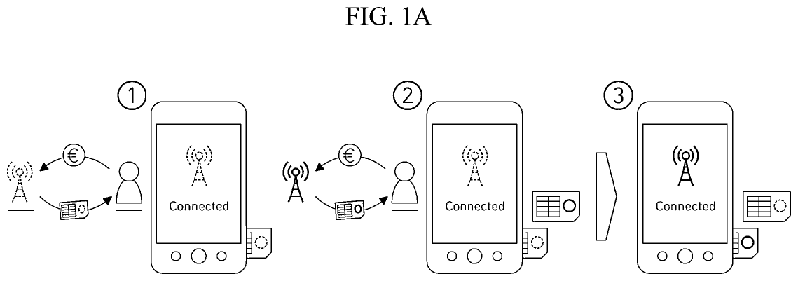

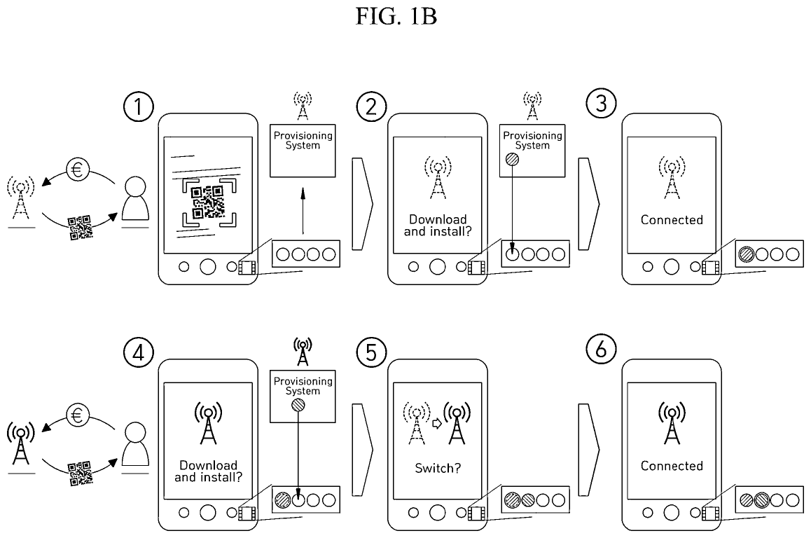

FIGS. 1A and 1B are diagrams illustrating a general provisioning procedure. FIGS. 1A and 1B are diagrams introducing a conventional remote provisioning procedure.

FIG. 1A is a diagram illustrating a provisioning procedure using a subscriber identity module (SIM) card (universal SIM (uSIM)). Conventionally, when a new profile is desired to be applied, a SIM possessed by the client is replaced with a new SIM and installed for use.

FIG. 1B is a diagram illustrating a remote SIM provisioning procedure using an embedded SIM (eSIM). Remote provisioning refers to a server-led process of changing a profile of a SIM of a client device or performing provisioning of a new profile with over-the-air (OTA). For this, the profile is generated by a subscription manager-data preparation (SM-DP) server and delivered through a secure transmission channel between a subscription manager-secure routing (SM-SR) server and an embedded universal integrated circuit card (eUICC, referred to as an eSIM). When applying a profile to M2M in an IoT environment, provisioning is performed as described above. The method shown in FIG. 1B has a benefit of allowing multiple devices to easily download profiles from the server at one time without the need for client intervention. However, the method shown in FIG. 1B is inefficient in terms of device management when a device is replaced due to a malfunction or when a client attempts to download a profile directly from a replacement target device. Furthermore, when replacing a device due to a malfunction, it is more efficient to reuse the profile of the existing device rather than downloading a new profile from the server because a new device replaces the previously used device.

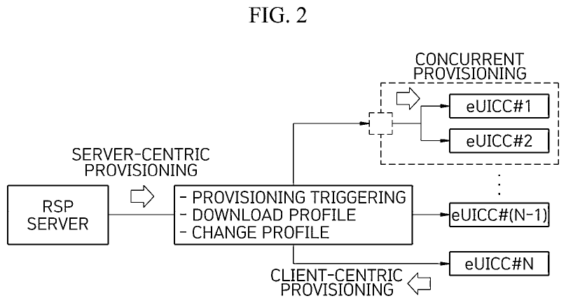

For example, when a general provisioning method shown in FIG. 1 is applied to an environment shown in FIG. 2 and provisioning is performed on a first apparatus eUICC #1, a second apparatus eUICC #2, . . . , and an N^{th} apparatus eUICC #N, provisioning is performed on the first apparatus eUICC #1, performed on the second apparatus eUICC #2, and so on, up to the N^{th} apparatus eUICC #N. Therefore, when applying profiles to IoT apparatuses (which may be referred to as “IoT devices”), a similar task of applying a profile to an individual device is repeatedly performed, which increases the time required to apply profiles or perform a service.

Therefore, depending on the network environment, client-centric provisioning or concurrent provisioning as shown in FIG. 2 is required.

The general remote provisioning method shown in FIG. 1B is a method in which the server determines the profile application target and method, and is suitable for a small number of devices or a single device, but is not effective in providing services to multiple IoT devices in the above environment. Therefore, rather than unilaterally applying server-centric provisioning to clients, the most effective method needs to be determined by considering the initiator and direction of provisioning and the need for concurrent provisioning.

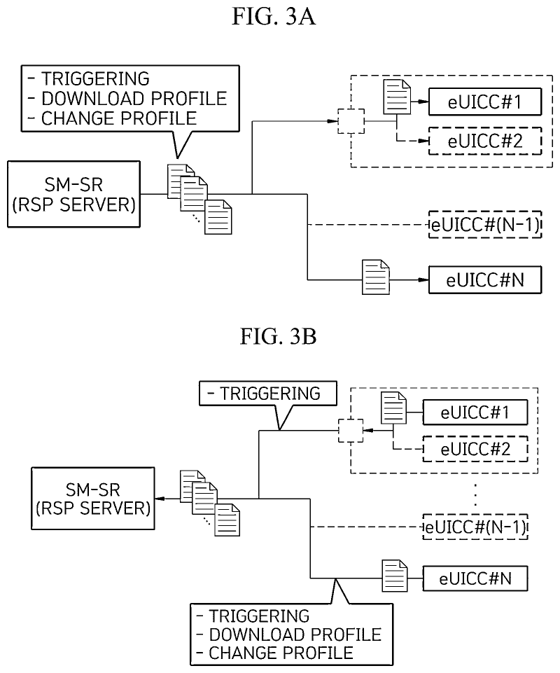

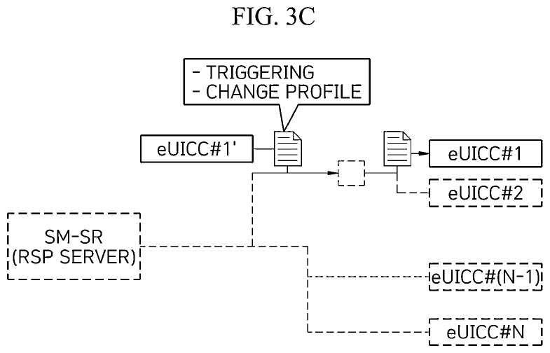

FIGS. 3A to 3C are diagrams illustrating considerations and operation flows of client-centric remote profile provisioning according to the present invention.

FIGS. 3A to 3C schematically illustrate the concept of a method of client-centric remote profile provisioning according to the present invention. The remote provisioning process is complex and composed of a large number of processes, but for the sake of convenience of description, the present specification briefly divides the remote provisioning process into a triggering process, a profile download process, and a profile change process. In addition to triggering, profile download, and profile change, other detailed processes need to be performed to perform smooth provisioning. The other processes are performed in compliance with the specifications of the GSMA's RSP standard documents. For example, in addition to the three processes described above, there may be other detailed processes, such as profile deactivation or profile deletion.

As described above, the present specification focuses on three cases: triggering, profile download, and profile change. “Triggering” is a request process to start provisioning. According to the request (trigger), a profile is downloaded to a device. Additionally, the present specification describes a process of changing a profile of a device when the device has an error and the device is replaced with a new device. In the present invention, “profile download” refers to a process of delivering a profile from an SM-SR server to a device, and “profile change” refers to a process of delivering a profile from one device to another device.

FIG. 3A shows an operation flow in which profile download or profile change is achieved through triggering of a SM-SR server (hereinafter referred to as “RSP server,” “server,” or “SM-SR”), FIG. 3B shows an operation flow in which a profile download or profile change is achieved with the intervention of a server through triggering of a device, and FIG. 3C shows an operation flow in which profile change is achieved between devices without the intervention of a server through triggering of a device.

Referring to FIGS. 3A to 3C, for the present invention, triggering, profile download, and profile change need to be performed in a server-centric or client-centric manner, and need to be performed concurrently on multiple devices. However, a general remote provisioning method generates a short message service (SMS) or transmission control protocol/internet protocol (TCP/IP)-based channel for triggering/profile download and uses the channel. For example, the general remote provisioning method is performed by establishing a hypertext transfer protocol (HTTP) session over TCP/IP and delivering relevant messages to the session. However, the channels are unsuitable and inefficient for supporting the environment shown in FIGS. 3A to 3C. In particular, the SMS is a protocol designed to transmit relatively simple data, which is an ineffective solution for delivering medium to large unit data to small groups at one time. Additionally, new low-power wide area networks, such as narrowband IoT (NB-IoT) for low-end IoT devices, do not support the SMS by default.

Therefore, in the present invention, in order to overcome the limitations of the SMS and TCP/IP protocols described above, message queuing telemetry transport (MQTT) is used as a lower-level communication method. MQTT is a publication-subscription-based message transmission and reception protocol designed to enable large-scale traffic transmission in a limited bandwidth, such as in IoT, or M2M environments. The protocol operates on the TCP/IP protocol, but has a relatively light load, is effective for 1: N message transmission, and ensures quality of service (QOS) for messages. MQTT is a method in which when a transmitter publishes a topic and generates a message to be delivered in the topic, receivers subscribe to the topic such that all receivers receive the message at one time. Therefore, the present invention utilizes MQTT to effectively perform triggering and message delivery when performing remote provisioning on multiple devices.

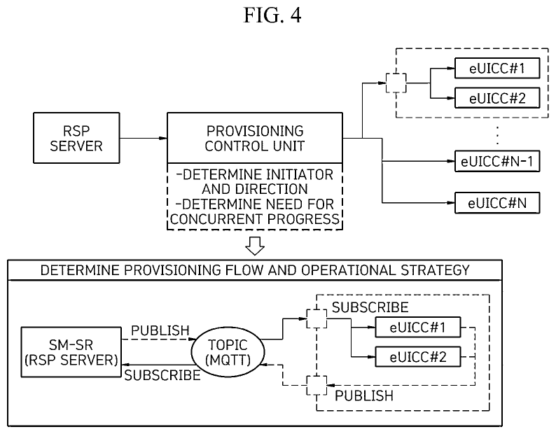

FIG. 4 is a diagram for describing an operation of a client-based provisioning control unit according to an embodiment of the present invention.

FIG. 4 schematically illustrates the concept of client-based provisioning control according to the present invention, which effectively performs provisioning by taking all of the above-described points into consideration.

In order to implement the method of remote provisioning according to the present invention, an additional apparatus referred to as a provisioning control unit is required between the existing server and the device. The provisioning control unit according to the present invention is functionally distinguished from the server and the device, but may physically be included in the server or may be present separately. The provisioning control unit determines the initiator and direction (direction of progress) of provisioning and the need for concurrent provisioning in remote provisioning. In addition, the provisioning control unit generates topics for client-centric provisioning and concurrent provisioning, and supports triggering, profile download, and profile change processes through publishing and subscribing according to the MQTT protocol based on the topics.

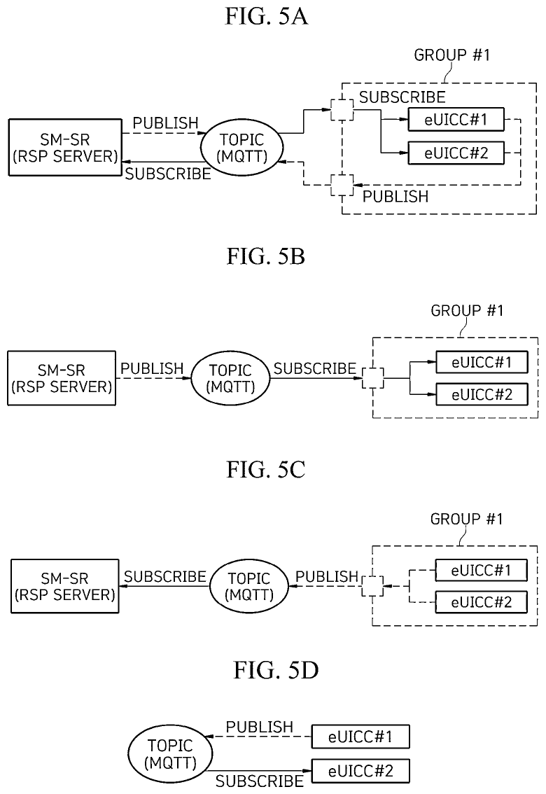

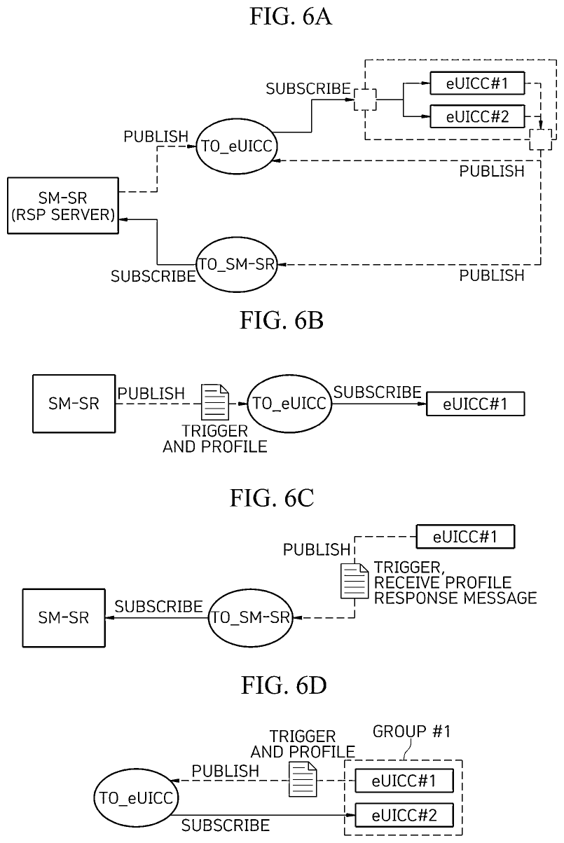

When provisioning control as shown in FIG. 4 is performed according to the present invention, provisioning flows as shown in FIGS. 5A to 5D to effectively perform concurrent provisioning on M2M IoT devices are determined, and in terms of implementation, topics to be generated and the relationships between the topics are determined as shown in FIGS. 6A to 6D.

FIGS. 5A to 5D are diagrams illustrating operation flows of client-centric remote profile provisioning according to an embodiment of the present invention. FIGS. 5A to 5D schematically illustrate the concept of operation flows of the client-centric remote profile provisioning presented according to the present invention. FIG. 5A is a TOPIC publication/subscription relationship diagram for message transmission and reception between the SM-SR (RSP server, Remote) and the eUICC. FIGS. 5B to 5D show TOPIC publication/subscription relationships in a case of delivering a message from the SM-SR to the eUICC (FIG. 5B), a reverse case (FIG. 5C), and a case of delivering a message from an eUICC to an eUICC (FIG. 5D), based on the relationship shown in FIG. 5A. An embodiment that may effectively support the provisioning process based on these relationships is described with reference to FIG. 6.

FIGS. 6A to 6D are diagrams for describing an embodiment of a method of remote profile provisioning according to an embodiment of the present invention.

As shown in FIG. 6A, a provisioning control unit 1000 generates a To_eUICC topic and a To_SM-SR topic for message transmission/reception between the SM-SR (a server) and the eUICC (a device). The provisioning control unit 1000, in an initialization stage, generates the topics and sets the publication/subscription relationship as shown in FIGS. 6B to 6D according to the relationship between the server and the device. FIG. 6B shows a process in which the SM-SR utilizes the To_eUICC topic to deliver a profile to the eUICC in server-centric provisioning. FIG. 6C shows a process of client-centric provisioning, in which the device transmits a trigger and a profile reception response message (a response message transmitted to the server after receiving a profile from the server) through the To_SM-SR topic. FIG. 6D shows a process of client-centric provisioning, in which profile change between devices is performed.

Next, the message type and exchange method used in the remote provisioning method according to the present invention is described.

For effective provisioning, the present invention changes the protocol used for message delivery from the existing general TCP/IP or SMS to MQTT. Therefore, a provisioning procedure and a message exchange method suitable for this purpose are designed. This is because the existing method may not express the performance entity/direction, concurrency, and the like, which are considerations of the present invention, in the message exchange method. The present invention defines the message type used for remote provisioning as shown in Table 1.

TABLE 1

| | |
|---|---|
| Message type | Message |

| | | |
|---|---|---|
| (A) | Server-centric triggering | (A1), (A2) |
| (B) | Single-mode provisioning | (B1), (B2) |
| (C) | multi-mode provisioning | (C1), (C2) |
| (D) | client-centric triggering | (D1), (D2) |
| (E) | client-centric profile change | (E1), (E2) |

The points considered in determining the message type in Table 1 are as follows. The main idea of the present invention is to apply provisioning to an appropriate target device (eUICC) at the moment the device requires provisioning. The existing method targets a single device and operates such that a message is unilaterally transmitted from the server to the client rather than being transmitted when provisioning is required. Therefore, in order to effectively achieve this main idea, there is a need to change the delivery method such that a message may be delivered when needed, and also provide a method of transmitting a message to the server with the client taking center stage, as well as a method of transmitting messages to the client with the server taking center stage.

To this end, the present invention considers characteristics such as providing diversity in the initiator and direction of provisioning and the need to perform concurrent provisioning on multiple devices when performing the provisioning process. The characteristics of the provisioning initiator are to reflect a case in which a client serves as the main agent and requests provisioning, in addition to a method in which a server serves as the main agent and downloads/installs profiles on target clients. The characteristics of the direction of provisioning are to reflect a case, unlike general cases in which the profile is transmitted from the server to the client, such as in a device replacement in which the profile needs to be transmitted directly from a client to a client. The characteristics of the need to perform concurrent provisioning on multiple devices are to perform provisioning in a 1: N concurrent transmission method rather than delivery to a target device in a server/client 1:1 transmission method.

Therefore, in the present invention, the provisioning initiator is divided by server-centric triggering and client-centric triggering depending on who transmits the triggering notifying the start. The direction of provisioning progress is classified as downward when the profile is transmitted from the server to the client, upward when the profile is transmitted from the client to the server, and parallel channel when the profile is transmitted from the client to the client. The need to perform concurrent provisioning on multiple devices is classified as a single mode (which may be referred to as “a single transmission mode”) when the profile is transmitted to only one device and a multi-mode (which may be referred to as “multi-transmission mode”) when the profile is transmitted concurrently to multiple devices.

TABLE 2

| Message | Descriptions | Related topics | Message format |
|---|---|---|---|
| (A1) | Server-based RSP | To_eUICC | {nid = 0, gid, |
| | trigger request | | trigger} or |
| | | | {nid, gid = 0, |
| | | | trigger} |
| (A2) | Result of Server- | To_SM-SR | {nid = 0, gid, |
| | based RSP trigger | | ret(trigger)} or |
| | request | | {nid, gid = 0, |
| | | | ret(trigger)} |
| (B1) | Single mode RSP | To_eUICC | {nid, gid = 0, |
| | request | | msg} |
| (B2) | Result of Single mode | To_SM-SR | {nid, gid = 0, |
| | RSP request | | ret(msg)} |
| (C1) | Multiple mode RSP | To_eUICC | {nid = 0, |
| | request | | gid, msg} |
| (C2) | Result of Multiple | To_SM-SR | {nid = 0, |
| | mode RSP request | | gid, ret(msg)} |
| (D1) | Client-base RSP | To_SM-SR | {nid = 0, gid, |
| | request #1 | | trigger} or |
| | | | {nid, gid = 0, |
| | | | trigger} |
| (D2) | Result of Client-base | To_eUICC | {nid = 0, gid, |
| | RSP request #1 | | ret(trigger)} or |
| | | | {nid, gid = 0, |
| | | | ret(trigger)} |
| (E1) | Client-base RSP | To_eUICC | {nid1, gid, |
| | request #2 | | req(nid2)} |
| (E2) | Result of Client-base | To_eUICC | {nid2, gid, |
| | RSP request #2 | | profile(nid1)} |

Table 2 shows the structure of a provisioning message format according to the present invention. The five message types shown in Table 1 may be effectively delivered through the message format shown in Table 2. Here, the contents of the message to be delivered during the provisioning process need to include triggering message requests/results and various command message requests/results related to provisioning. Additionally, the device to which the message is to be delivered and whether the transmission is single mode transmission or multi-mode transmission need to be additionally included. Therefore, when transmitting to only one target, an ID value that may identify the device is indicated, and when transmitting to multiple devices, all of the devices are grouped together and assigned the same ID value, and the message is transmitted using the value. Therefore, the message format includes a device ID, a group ID, a message type, and message content, and is expressed in the form of {“nid,” “gid,” “type,” “body”}. “nid” is a value to distinguish individual eUICCs, and “gid” is a value to distinguish eUICC groups. Here, when the “nid” value is not 0 and the “gid” value is 0, it indicates a single transmission mode for a single device. The opposite case indicates a multi-transmission mode for multiple devices. Type includes {“trigger”|“msg”|“ret(trigger)”|“ret(msg)”|“req(nid)”|“profile(nid)”}. Here, the triggering message request and response has a value of “trigger”/“ret(trigger),” the provisioning-related command message request and response has a value of “msg”/“ret(msg),” and the client-centric profile change request and response has a value of “req(nid)”/“profile(nid)”. In addition, detailed items of “msg,” “trigger,” and “ret” are used for device authentication and transmission data protection by applying the message specifications and encryption method used in the previous GSMA RSP standard.

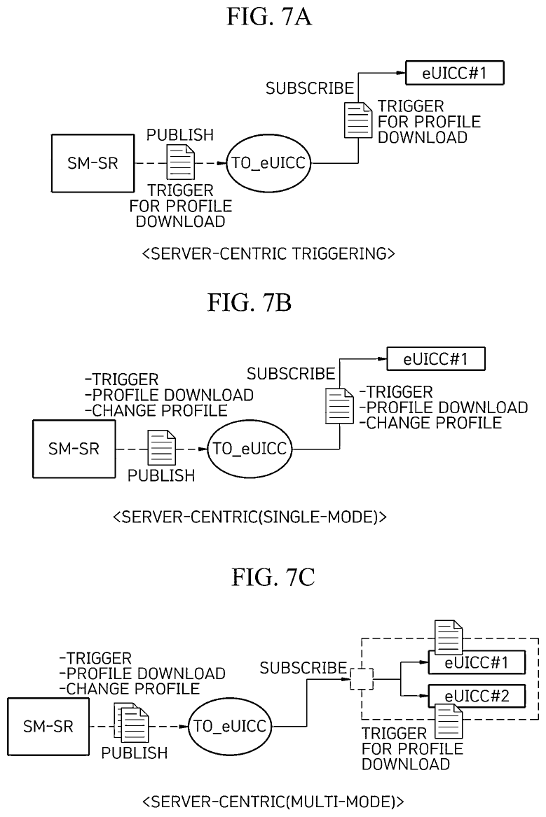

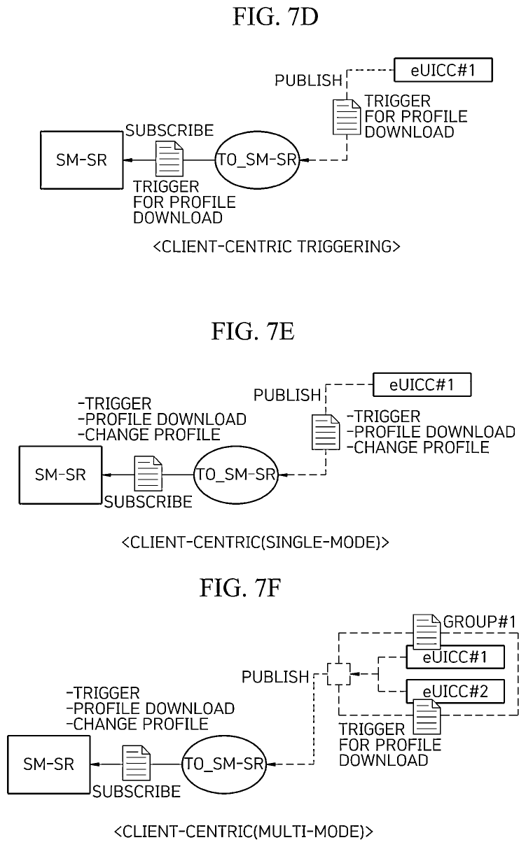

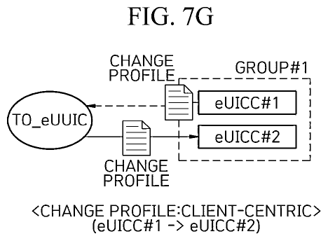

FIGS. 7A to 7G are diagrams for describing a method of remote profile provisioning according to an embodiment of the present invention.

FIGS. 7A to 7G are detailed schematic representations of the provisioning method according to the present invention, schematically representing each case of server-centric provisioning (FIGS. 7A to 7C), client-centric provisioning (FIGS. 7D to 7F), and client-centric profile change (FIG. 7G).

To describe each case in detail, the server-centric provisioning process is a flow in which the SM-SR transmits a triggering message to the eUICC and performs a provisioning command. In the case of single mode, the process proceeds in the order (A)→(B), and in the case of multi-mode, the process proceeds in the order (A)→(C) (see Table 1 and Table 2 for the message types (A) to (E)). When the existing provisioning method is applied to multiple devices, the process (A)→(B) is repeated as many times as the number of devices whereas the provisioning method according to the embodiment of the present invention requires the process (A)→(C) only to be performed once, providing simplicity and more efficiency. FIG. 7A shows a process in which when the SM-SR publishes a triggering message for profile download to the To_eUICC topic, the message is delivered to the eUICC device subscribing to the topic. FIG. 7B shows a process in which the SM-SR publishes various messages through the To-eUICC topic and delivers the messages to the eUICC device subscribing to the topic. The messages that may be published by the SM-SR include a triggering message, a profile download message, a profile change message, and the like. According to the present invention, even when the triggering occurs in the server, the direction of progress may be parallel. That is, according to an embodiment of the present invention, server-centric profile change may also be performed, and in this case, the process is performed in the order (A)→(E). The triggering message is published by the SM-SR, but the actual profile change occurs between eUICC devices. FIG. 7C shows a process in which a triggering message regarding profile download is delivered to a plurality of eUICCs.

In addition, the client-centric provisioning process, which is a newly added method, is a flow in which a triggering message is transmitted from the eUICC to the SM-SR, and a provisioning command is performed. In the case of single mode, the proceeds in the order (D)→(A)→(B), and in the case of multi-mode, the process in the order (D)→(A)→(C). In this method, the client transmits a triggering message indicating that provisioning is required to the server, and afterward, the existing provisioning process is performed, which allows provisioning to be performed on a desired target at a desired moment. In other words, when attempting to add a new eUICC, the existing provisioning method has difficulty in immediately restarting the service after adding a new device until the server recognizes the demand and transmits an RSP triggering message. However, using the client-centric provisioning enables provisioning to be rapidly performed on an appropriate device at an appropriate moment, thereby ensuring service continuity and safety, providing efficiency. FIG. 7D shows a process in which when the eUICC publishes a triggering message for profile download to the To_SM-SR topic, the message is delivered to the SM-SR (the server) subscribing to the topic. FIG. 7E shows a process in which the eUICC publishes various messages through the To-SM-SR topic, and the published messages are delivered to the SM-SR subscribing to the topic. The messages that may be published by the eUICC include a triggering message, a profile download message, a profile change message, and the like.

For reference, the messages related to profile change need to be delivered to the SM-SR. The SM-SR (the server) actually manages information about the profile applied to the eUICC. When the profile of a device (eUICC) is changed, the SM-SR (server) recognizes the change and delivers service-related commands that match the changed profile to the device. Since provisioning is a preliminary task required to authenticate/verify the identity of a device to perform a service, when the profile of the eUICC is changed from eUICC #1→eUICC #1′ through a profile change, the device eUICC needs to transmit information related to the profile change to the SM-SR through the To_SM-SR topic.

Meanwhile, FIG. 7F shows a process in which a plurality of eUICCs publish a triggering message regarding profile download to the To-SM-SR topic, and the message is delivered to the SM-SR subscribing to the To-SM-SR topic.

Lastly, the client-centric profile change is a flow of transmitting a profile change request from an eUICC to an eUICC and receiving a profile (see FIG. 7G). The client-centric profile change proceeds in the order (E1)→(E2) (see Table 2). However, in this case, unlike the existing server-centric/client-centric provisioning using two topics, the “To_eUICC” topic is shared to deliver messages and profiles. In other words, both the device transmitting the profile and the device receiving the profile concurrently publish/subscribe to the “To_eUICC”. When a new device (nid2, a profile application target) transmits a message E1 {nid1, gid, req(nid2)} to a replacement device (nid1, the existing device, that is, a message receiving target), the replacement device nid1 delivers a message E2 {nid2, gid, profile(nid1)} as a result of receiving the message E1. That is, the replacement device nid1 may transmit the profile thereof to nid2 through the To-eUICC topic. The above-described process applies when replacing a device and reusing a previously used profile, and is only possible when both devices meet the same pre-agreed system environment and operating conditions. Otherwise, a new device is added and client-centric provisioning is performed to apply the profile to the new device.

As described above, the method according to the present invention is implemented to, instead of unilaterally performing server-centric provisioning on the client, effectively perform bidirectional provisioning such that provisioning may be applied at a desired time and when a device requires provisioning.

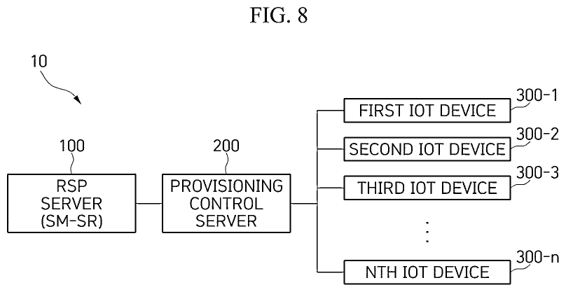

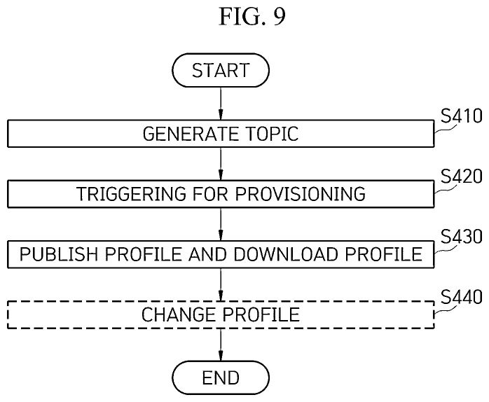

FIG. 8 is a block diagram illustrating a configuration of a system for remote profile provisioning according to an embodiment of the present invention.

A system 10 for remote provisioning according to an embodiment of the present invention is a system for remote profile provisioning for an IoT device supporting an embedded SIM (eSIM), and includes an RSP server (an SM-SR server) 100, a provisioning control server 200, and one or more IoT devices 300. The IoT device 300 includes an eUICC (an eSIM).

The RSP server 100 provides a profile to be applied to the IoT device 300, and the provisioning control server 200 operates topics (To-SM-SR and To_eUICC) according to the MQTT protocol to ensure that the provisioning process is smoothly performed. In addition, the provisioning control server 200 determines the initiator (server-centric, client-centric), the direction of progress (upward, downward, and parallel), and the need for concurrent progress (single mode, multi-mode) in remote provisioning. When there are a plurality of IoT devices 300, the IoT devices 300 are classified as a first IoT device 300-1, a second IoT device 300-2, . . . , and an n^{th} IoT device 300-n.

The RSP server 100 and the provisioning control server 200 are logically separated from each other, but the provisioning control server 200 may be physically included in the RSP server 100. That is, depending on the embodiment, the RSP server 100 may perform the role of the provisioning control server 200. In this case, the RSP server 100 generates a topic according to the MQPP protocol and operates the topic.

The provisioning control server 200 generates a first topic To_SM-SR and a second topic To_eUICC according to the MQTT protocol and operates the first topic To_SM-SR and the second topic To_eUICC. The RSP server 100 subscribes to the first topic To_SM-SR, and the IoT device 300 subscribes to the second topic To_eUICC. For example, the first IoT device 300-1, the second IoT device 300-2, and the third IoT device 300-3 subscribe to the second topic To_eUICC.

In a profile download process according to an embodiment of the present invention, the RSP server 100 publishes a profile to be applied to the first IoT device 300-1 to the second topic To_eUICC, and the first IoT device 300-1 downloads the profile from the second topic To_eUICC.

As described above, the initiator of the profile download process may be the IoT device 300 (client-centric provisioning) or the RSP server 100 (server-centric provisioning) depending on the settings.

When the initiator is the IoT device 300-1, the first IoT device 300-1 publishes a triggering message to start provisioning to the first topic To_SM-SR before downloading the profile to request the RSP server 100 to publish the profile. That is, the first IoT device 300-1 publishes a triggering message to start provisioning to the first topic To_SM-SR, and when the RSP server 100 receives the triggering message and publishes the profile to be applied to the second topic To_eUICC, the first IoT device 300-1 downloads the profile from the second topic To_eUICC.

When the initiator is the RSP server 100, the RSP server 100 publishes a triggering message to start provisioning to the second topic To_eUICC before publishing the profile to the second topic To_eUICC to request the first IoT device 300-1 to download the profile. That is, the RSP server 100 publishes a triggering message to start provisioning to the second topic To_eUICC, and when the first IoT device 300-1 responds to the triggering message, the RSP server 100 publishes the profile to be applied to the first IoT device 300-1 to the second topic To_eUICC. Afterward, the first IoT device 300-1 downloads the profile from the second topic To_eUICC.

As described above, the provisioning control server 200 may set the second topic To_eUICC to which the IoT device 300 subscribes to one of a multi-mode and a single mode. For example, when the second topic To_eUICC is set to a multi-mode by the provisioning control server 200, the second IoT device 300-2 may, when the RSP server 100 publishes a profile to the second topic To_eUICC, download the profile from the second IoT device 300-2.

Hereinafter, the profile change process of the remote provisioning system 10 is described. For example, the first IoT device 300-1 may transmit its own profile to the third IoT device 300-3 through the provisioning control server 200.

First, the third IoT device 300-3 publishes a triggering message to start provisioning to the second topic To_eUICC with the first IoT device 300-1 as a receiving target to request the first IoT device 300-1 to publish the profile possessed by the first IoT device 300-1.

The first IoT device 300-1, upon receiving the triggering message published by the third IoT device 300-3 from the second topic To_eUICC, publishes its own profile to the second topic To_eUICC with the third IoT device 300-3 as a receiving target. The third IoT device 300-3, in response to the first IoT device 300-1 publishing the profile to the second topic To_eUICC, downloads the profile from the second topic To_eUICC.

FIG. 9 is a flowchart showing a method of client-centric remote profile provisioning according to an embodiment of the present invention. The method of client-centric remote profile provisioning according to the embodiment of the present invention may be performed by the system 10 for remote provisioning.

The method of client-centric remote profile provisioning according to an embodiment of the present invention is a remote profile provisioning method for an M2M IoT device supporting an eSIM, and includes operations S410 to S430, and may further include operation S440. Operation S440 may be performed independently of operations S420 to S430. For example, operation S440 may be performed after operation S410.

Operation S410 is a topic generation operation. The provisioning control server 200 generates a first topic To_SM-SR to which the RSP server 100 is set to subscribe and a second topic To_eUICC to which the IoT device 300 is set to subscribe according to the MQTT protocol. The provisioning control server 200 operates the first topic and the second topic, thereby supporting provisioning.

Operation S420 is a triggering operation for provisioning. In this operation, the provisioning initiator publishes a triggering message to the topic operated by the provisioning control server 200 according to the settings of the provisioning control server 200. The initiator may be the RSP server 100 or the IoT device 300 depending on the settings of the provisioning control server 200.

In one embodiment of the present invention, when the initiator is set to the IoT device 300, client-oriented provisioning is performed. For example, the first IoT device 300-1 publishes a triggering message to start provisioning to the first topic to request the RSP server 100 to publish a profile to be applied to the first IoT device 300-1. Thereafter, operation S430 proceeds.

In one embodiment of the present invention, when the initiator is set to the RSP server 100, server-centric provisioning is performed. For example, the RSP server 100 publishes a triggering message to start provisioning to the second topic, and the first IoT device 300-1 receives the triggering message from the second topic, and in response to the triggering message, publishes a message to the first topic. When the first IoT device 300-1 publishes a message agreeing to the triggering message to the first topic, operation S430 proceeds.

Operation S430 is a profile publication and download operation.

In this operation, the RSP server 100 publishes a profile to the second topic, and the IoT device 300 downloads the profile from the second topic.

For example, in client-centric provisioning, the RSP server 100 publishes the profile to the second topic in response to the triggering message of the first IoT device 300-1, and the first IoT device 300-1 downloads the profile from the second topic.

As another example, in server-centric provisioning, the RSP server 100, upon receiving a response message (agreeing to profile download) of the first IoT device 300-1 from the first topic, publishes the profile to be applied to the first IoT device 300-1 to the second topic, and the first IoT device 300-1 downloads the profile from the second topic.

Meanwhile, the provisioning control server 200 may set the second topic to a single mode or a multi-mode. When the second topic is set to a multi-mode, the profile published to the second topic is delivered to the IoT device 300 subscribing to the second topic. For example, when a profile is published to the second topic by the RSP server 100, the second IoT device 300-2 subscribing to the second topic downloads the profile from the second topic.

After operation S430 or after operation S410, profile change between IoT devices 300 may be performed (S440).

Operation S440 is a profile change operation, and a triggering message and a profile may be exchanged between the IoT devices 300. However, the RSP server 100 receives information related to the profile change from the provisioning control server 200 and identifies whether the profile change has occurred.

For example, the third IoT device 300-3 subscribing to the second topic publishes a triggering message to start provisioning to the second topic with the first IoT device 300-1 as a receiving target to request the first IoT device 300-1 to publish a profile possessed by the first IoT device 300-1. The first IoT device 300-1 receives the triggering message published by the third IoT device 300-3 from the second topic, and publishes its own profile to the second topic with the third IoT device 300-3 as a receiving target. The third IoT device 300-3, in response to the first IoT device 300-1 publishing the profile to the second topic, downloads the profile from the second topic and applies the profile, thereby completing profile change.

Meanwhile, the content described in FIG. 8 may be applied to parts omitted in the description with reference to FIG. 9.

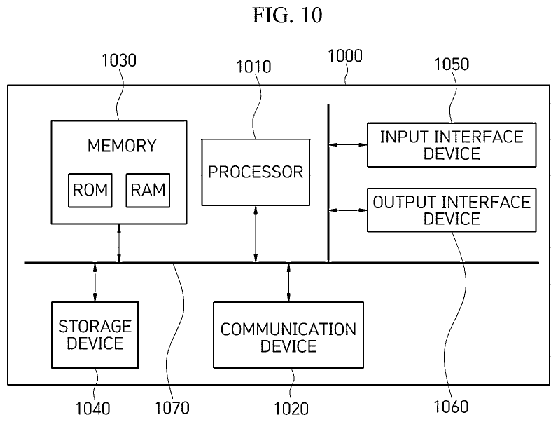

FIG. 10 is a block diagram illustrating a computer system for implementing a method of remote profile provisioning according to an embodiment of the present invention.

At least one of the RSP server 100, the provisioning control server 200, and the IoT device 300 according to the embodiment of the present invention may be in the form of the computer system shown in FIG. 10.

Referring to FIG. 10, a computer system 1000 may include at least one of a processor 1010, a memory 1030, an input interface device 1050, an output interface device 1060, and a storage device 1040, which communicate through a bus 1070. The computer system 1000 may further include a communication device 1020 coupled to a network. The processor 1010 may be a central processing unit (CPU) or a semiconductor device for executing instructions stored in the memory 1030 and/or storage device 1040. The memory 1030 and the storage device 1040 may include various forms of volatile or nonvolatile media. For example, the memory 1030 may include a read only memory (ROM) or a random-access memory (RAM). The memory 1030 may be located inside or outside the processor 1010 and may be connected to the processor 1010 through variously known means. The memory 1030 may include various forms of volatile or nonvolatile media, for example, may include a ROM or a RAM.

Accordingly, embodiments of the present invention may be embodied as a method implemented by a computer or non-transitory computer readable media in which computer executable instructions are stored. According to an embodiment, when executed by a processor, computer readable instructions may perform a method according to at least one aspect of the present disclosure.

The communication device 1020 may transmit or receive a wired signal or a wireless signal.

In addition, the method according to the present invention may be implemented in the form of program instructions executable by various computer devices and may be recorded on computer readable media.

The computer readable media may be provided with program instructions, data files, data structures, and the like alone or in combination. The program instructions stored in the computer readable media may be specially designed and constructed for the purposes of the present invention or may be well-known and available to those skilled in the art of computer software. The computer readable storage media include hardware devices configured to store and execute program instructions. For example, the computer readable storage media include magnetic media such as hard disks, floppy disks, and magnetic tape, optical media such as a compact disc (CD)-ROM and a digital video disk (DVD), magneto-optical media such as floptical disks, a ROM, a RAM, a flash memory, etc. The program instructions include not only machine language code made by a compiler but also high level code that can be used by an interpreter etc., which is executed by a computer.

Meanwhile, the contents of FIGS. 2 to 7 (FIGS. 7A to 7G) may be applied to FIGS. 8 to 10. Accordingly, the content described with reference to FIGS. 2 to 7 may be applied to parts omitted in the description FIGS. 8 to 10. For example, the message type and message format defined in Tables 1 and 2 may be applied to the message transmission and reception process according to FIGS. 8 to 10. Additionally, the contents of FIGS. 8 to 10 may be applied to FIGS. 2 to 7.

For reference, elements according to embodiments of the present invention may be implemented in the form of a software element or a hardware element such as a digital signal processor (DSP), a field programmable gate array (FPGA), an application specific integrated circuit (ASIC), etc., and may perform a corresponding function.

However, the “elements” are not limited to meaning software or hardware. Each of the elements may be configured to be stored in an addressable storage medium and configured to reproduce one or more processors.

Accordingly, examples of the elements may include elements such as software elements, object-oriented software elements, class elements, and task elements, processes, functions, attributes, procedures, subroutines, segments of program code, drivers, firmware, microcode, circuits, data, databases, data structures, tables, arrays, and variables.

Elements and functions provided in the corresponding elements may be combined into fewer elements or may be further divided into additional elements.

Meanwhile, it should be understood that the blocks and the operations shown in the flowcharts can be performed via computer program instructions. These computer program instructions can be installed on processors of programmable data processing equipment, special computers, or general purpose computers. The instructions executed via the processors of programmable data processing equipment or the computers can generate a unit that performs functions described in a block (blocks) of the flowchart. In order to implement functions in a particular manner, the computer program instructions can also be stored in a computer available memory or computer readable memory that can support computers or programmable data processing equipment. Therefore, the instructions stored in the computer available memory or computer readable memory can produce an article of manufacture containing an instruction unit that performs the functions described in the blocks of the flowchart therein). In addition, since the computer program instructions can also be installed on computers or programmable data processing equipment, the computer program instructions can create processes that are executed by a computer through a series of operations that are performed on a computer or other types of programmable data processing equipment so that the instructions are executed by the computer or other programmable data processing equipment and can provide operations for executing the functions described in a block (blocks) of the flowchart.

In addition, each block refers to a part of code, segments or modules that include one or more executable instructions to perform one or more logical functions. It should be noted that the functions described in the blocks may be performed in a different order from the embodiments described above. For example, the functions described in two blocks shown in succession may be performed at the same time or in reverse order in some cases.

The term “˜ unit” used in the present embodiment may be a software or hardware element such as FPGA or ASIC. Although the term “˜ unit” performs a certain role, but is not limited to a software or hardware element. The “˜ unit” may be implemented in addressable storage media. The “˜ unit” may also be configured to reproduce one or more processors. For example, the “˜ unit” may include various types of elements (e.g., software elements, object-oriented software elements, class elements, task elements, etc.), processes, functions, achieves, attributes, procedures, sub-routines, segments of program code, drivers, firmware, micro-code, circuits, data, databases, data structures, tables, arrays, variables, etc. Functions provided by elements and “˜ units” may be combined into fewer elements and “˜ units” or may be further divided into additional elements and “˜ units.” In addition, elements and “˜ units” may also be implemented to reproduce one or more CPUs in devices or security multi-cards.

The method of remote profile provisioning has been described above with reference to the flowcharts presented in the drawings. While the above method has been shown and described as a series of blocks for the purpose of simplicity, it is to be understood that the present invention is not limited to the order of the blocks, and that some blocks may be executed in a different order from those shown and described herein or executed concurrently with other blocks, and various other branches, flow paths, and sequences of blocks that achieve the same or similar results may be implemented. In addition, not all illustrated blocks may be required for implementation of the method described herein.

As is apparent from the above, the present invention can allow bidirectional provisioning to be effectively performed such that provisioning is applied to a large number of IoT devices with eSIMs operated in an M2M manner at a desired time and when the device requires provisioning.

The present invention can allow rapid and economical provisioning when performing profile provisioning on multiple IoT devices. For example, the environment in which devices operate may have poor mobile network conditions, such as low speed/narrow bandwidth. In this case, the provisioning in the conventional method requires a considerable amount of time in performing provisioning on a single device, and when performed on multiple devices, incurs repetitive performance costs, and thus it is uneconomical. This leads to increased initiation costs for starting the service. However, in this case, the method according to the present invention can eliminate repetitive processes in performing provisioning on multiple devices, and enable concurrent provisioning, thereby ensuring cost-effective provisioning and reducing service operation costs.

Additionally, when operating a service composed of multiple M2M-based IoT devices, the most effective provisioning can be provided. The conventional method performs provisioning on devices from a server-centric perspective, which generates an overload on the server and fails to reflect the status of IoT devices on the client side, which causes services to start after provision is performed on multiple devices for a long time. However, the present invention can select the most optimal method between server-based provisioning and client-based provisioning in consideration of various factors, such as the status of devices requiring provisioning and server conditions and apply the selected method, thereby performing rapid provisioning and effectively ensuring service continuity.

Lastly, the present invention can, when a device replacement request occurs during operation, allow the replacement request to be reflected in real time and effectively manage provisioning. For example, when a device needs to be replaced with a new device due to a malfunction or aging of the device during operation, a process of provisioning the new device needs to be led by the server in the conventional method. In other words, only by starting server-centric provisioning, profile provisioning to a new device starts, and a new profile needs to be published instead of the previously used profile, which makes it difficult to reuse the profile. However, the method according to the present invention allow, when a new device replacement request occurs, the existing device to deliver its profile to a new device for the profile to be reused, and instead of starting server-centric provisioning, the new device starts provisioning, thereby enabling effective provisioning in real time in accordance with the time of the new device replacement.

The effects of the present invention are not limited to those described above, and other effects not described above will be clearly understood by those skilled in the art from the above detailed description.

Although the present invention has been described with reference to the embodiments illustrated in the drawings, the embodiments disclosed above should be construed as being illustrative rather than limiting the present invention, and those skilled in the art should appreciate that various substitutions, modifications, and changes are possible without departing from the scope and spirit of the present invention. Therefore, the scope of the present invention is defined by the appended claims rather than by the foregoing description, and all changes or modifications derived from the meaning and scope of the claims and the equivalents thereof should be interpreted as being included in the scope of the present invention.

Although the present invention has been described in detail above with reference to the exemplary embodiments, those of ordinary skill in the technical field to which the present invention pertains should be able to understand that various modifications and alterations may be made without departing from the technical spirit and scope of the present invention.

What is claimed is:

1. A method of client-centric remote profile provisioning, which is a method of remote profile provisioning for an Internet of Things (IoT) device supporting an embedded subscriber identity module (eSIM, the method comprising:
generating, by a provisioning control server, a first topic to which a remote SIM provisioning (RSP) server is configured to subscribe and a second topic to which an IoT device is configured to subscribe, according to a message queueing telemetry transport (MQTT) protocol;
publishing, by a first IoT device, a triggering message to start provisioning to the first topic to request the RSP server to publish a profile to be applied to the first IoT device; and
publishing, by the RSP server, the profile to the second topic in response to the triggering message.

2. The method of claim 1, further comprising downloading, by the first IoT device, the profile from the second topic.

3. The method of claim 1, further comprising, when the second topic is set to a multi-mode, downloading, by a second IoT device subscribing to the second topic, the profile from the second topic when the profile is published to the second topic by the RSP server.

4. The method of claim 2, further comprising publishing, by a third IoT device subscribing to the second topic, a triggering message to start provisioning to the second topic with the first IoT device as a receiving target to request the first IoT device to publish the profile.

5. The method of claim 4, further comprising:
receiving, by the first IoT device, the triggering message published by the third IoT device from the second topic;
publishing, by the first IoT device, the profile to the second topic with the third IoT device as a receiving target; and
downloading, by the third IoT device, the profile from the second topic when the first IoT device publishes the profile to the second topic.

6. A system for remote profile provisioning for an Internet of Things (IoT) device supporting an embedded subscriber identity module (eSIM), the system comprising:
a provisioning control server configured to operate a first topic and a second topic generated according to a message queueing telemetry transport (MQTT) protocol;
a remote SIM provisioning (RSP) server configured to subscribe to the first topic; and
a first IoT device configured to subscribe to the second topic,
wherein the RSP server publishes a profile to be applied to the first IoT device to the second topic, and
the first IoT device downloads the profile from the second topic.

7. The system of claim 6, wherein, before downloading the profile, the first IoT device publishes a triggering message to start provisioning to the first topic to request the RSP server to publish the profile.

8. The system of claim 6, wherein, before publishing the profile to the second topic, the RSP server publishes a triggering message to start provisioning to the second topic to request the first IoT device to download the profile.

9. The system of claim 6, further comprising a second IoT device subscribing to the second topic,
wherein the provisioning control server sets the second topic to one of a multi-mode and a single mode, and
when the second topic is set to the multi-mode, the second IoT device downloads the profile from the second topic in response to the RSP server publishing the profile to the second topic.

10. The system of claim 6, further comprising a third IoT device subscribing to the second topic,
wherein the third IoT device publishes a triggering message to start provisioning to the second topic with the first IoT device as a receiving target to request the first IoT device to publish the profile.

11. The system of claim 10, wherein, upon receiving the triggering message published by the third IoT device from the second topic, the first IoT device publishes the profile to the second topic with the third IoT device as a receiving target, and
when the first IoT device publishes the profile to the second topic, the third IoT device downloads the profile from the second topic.

12. A system for remote profile provisioning for an Internet of Things (IoT) device supporting an embedded subscriber identity module (eSIM), the system comprising:
a remote SIM provisioning (RSP) server configured to operate a first topic and a second topic generated according to a message queueing telemetry transport (MQTT) protocol, and subscribe to the first topic; and
a first IoT device configured to subscribe to the second topic,
wherein the RSP server publishes a profile to be applied to the first IoT device to the second topic, and
the first IoT device downloads the profile from the second topic.

13. The system of claim 12, wherein, before downloading the profile, the first IoT device publishes a triggering message to start provisioning to the first topic to request the RSP server to publish the profile.

14. The system of claim 12, wherein, before publishing the profile to the second topic, the RSP server publishes a triggering message to start provisioning to the second topic to request the first IoT device to download the profile.

15. The system of claim 12, further comprising a second IoT device subscribing to the second topic,
wherein the RSP server sets the second topic to one of a multi-mode and a single mode, and
when the second topic is set to the multi-mode, the second IoT device downloads the profile from the second topic in response to the RSP server publishing the profile to the second topic.

16. The system of claim 12, further comprising a third IoT device subscribing to the second topic,
wherein the third IoT device publishes a triggering message to start provisioning to the second topic with the first IoT device as a receiving target to request the first IoT device to publish the profile.

17. The system of claim 16, wherein, upon receiving the triggering message published by the third IoT device from the second topic, the first IoT device publishes the profile to the second topic with the third IoT device as a receiving target, and
when the first IoT device publishes the profile to the second topic, the third IoT device downloads the profile from the second topic.
